(19) United States
(12) Patent Application Publication
(10) Pub. No.: US 2026/0359628 A1
(43) Pub. Date: Nov. 12, 2026

(54) SYSTEMS AND METHODS FOR ENHANCING LARGE LANGUAGE MODEL RELIABILITY WITH HALLUCINATION AVERSE FINE-TUNING AND DETECTION

(71) Applicant: JPMORGAN CHASE BANK, N.A., New York, NY (US)

(72) Inventors: Kumud LAKARA, Oxford (GB); Ruibo SHI, London (GB); Fanny SILAVONG, London (GB)

(21) Appl. No.: 19/537,982

(22) Filed: Feb. 12, 2026

Related U.S. Application Data
(60) Provisional application No. 63/757,618, filed on Feb. 12, 2025.

(51) Int. Cl. G06N 3/08; G06N 3/047

(52) U.S. Cl. CPC G06N 3/08; G06N 3/047

(57) ABSTRACT

A method may include: receiving, by a computer program, pairs of conversation text and summaries; generating, by the computer program, training data by injecting hallucinations into the conversation text or the summaries; fine-tuning, by the computer program, a large language model (LLM) with the generated training data using a loss function; providing, by the computer program, validation conversation text to the fine-tuned LLM; generating, by the computer program, a lookback ratio vector comprising attention paid by the fine-tuned LLM to content at each token generation step; extracting, by the computer program, token probabilities at each layer of the fine-tuned LLM into a logit-based vector; concatenating, by the computer program, the lookback ratio vector and the logit-based vector; classifying, by the computer program, the concatenated lookback ratio vector and the logit-based vector using a logistic regression classifier; and deploying, by the computer program, the LLM to a production environment.

### RELATED APPLICATIONS

This application claims priority to, and the benefit of, U.S.

Provisional Patent Application Ser. No. 63/757,618, filed Feb. 12, 2025, the disclosure of which is hereby incorporated, by reference, in its entirety.

### BACKGROUND OF THE INVENTION

### 1. Field of the Invention

Embodiments relate to systems and methods for enhancing large language model reliability with hallucination averse fine-tuning and detections.

### 2. Description of the Related Art

Large Language Models (LLMs) have exhibited remarkable proficiency in generating high-quality text; however, their propensity for producing hallucinations poses a significant challenge for their deployment in security-critical domains.

### SUMMARY OF THE INVENTION

Systems and methods for enhancing large language model reliability with hallucination averse fine-tuning and detections are disclosed.

According to an embodiment, a method may include: receiving, by a computer program executed by an electronic device, pairs of conversation text and summaries; generating, by the computer program, training data by injecting hallucinations into the conversation text or the summaries; fine-tuning, by the computer program, a large language model (LLM) with the generated training data using a loss function; providing, by the computer program, validation conversation text to the fine-tuned LLM; generating, by the computer program, a lookback ratio vector comprising attention paid by the fine-tuned LLM to content at each token generation step; extracting, by the computer program, token probabilities at each layer of the fine-tuned LLM into a logit-based vector; concatenating, by the computer program, the lookback ratio vector and the logit-based vector; classifying, by the computer program, the concatenated lookback ratio vector and the logit-based vector using a logistic regression classifier; and deploying, by the computer program, the LLM to a production environment.

In an embodiment, the step of generating training data by injecting hallucinations into the conversation text or the summaries comprises: extracting, by the computer program, named entities from the conversation text or the summaries; factually augmenting, by the computer program, the named entities within the conversation text or the summaries; and introducing, by the computer program, external content into the summaries by paraphrasing parts of the conversation text or the summaries.

In an embodiment, the hallucinations are injected by replacing a proportion of the named entities with related but false values.

In an embodiment, the hallucinations are injected according to a hallucination ratio, a location in the conversation text or summaries, and/or a natural language inference sentiment of the conversation text or the summaries.

In an embodiment, the hallucinations are injected by paraphrasing the summaries and injecting hallucinations.

In an embodiment, the loss function is direct preference optimization.

According to another embodiment, a system may include: a database comprising a plurality of conversation text-summary pairs; an electronic device executing a computer program; and a large language model (LLM). The computer program is configured to receive pairs of conversation text and summaries; the computer program is configured to generate training data by injecting hallucinations into the conversation text or the summaries; the computer program is configured to fine-tune the LLM with the generated training data using a loss function; the computer program is configured to provide validation conversation text to the fine-tuned LLM; the computer program is configured to generate a lookback ratio vector comprising attention paid by the fine-tuned LLM to content at each token generation step; the computer program is configured to extract token probabilities at each layer of the fine-tuned LLM into a logit-based vector; the computer program is configured to concatenate the lookback ratio vector and the logit-based vector; the computer program is configured to classify the concatenated lookback ratio vector and the logit-based vector using a logistic regression classifier; the computer program is configured to detect hallucinations in an output of the fine-tuned LLM; and the computer program is configured to deploy the fine-tuned LLM to a production environment.

In an embodiment, the hallucinations are injected into the conversation text or the summaries by: the computer program is configured to extracting named entities from the conversation text or the summaries; factually augmenting the named entities within the conversation text or the summaries; and introducing external content into the summaries by paraphrasing parts of the conversation text or the summaries.

In an embodiment, the hallucinations are injected by replacing a proportion of the named entities with related but false values.

In an embodiment, the hallucinations are injected according to a hallucination ratio, a location in the conversation text or summaries, and/or a natural language inference sentiment of the conversation text or the summary.

In an embodiment, the hallucinations are injected by paraphrasing the summaries and injecting hallucinations.

In an embodiment, the loss function is direct preference optimization.

According to another embodiment, a non-transitory computer readable storage medium may include instructions stored thereon, which when read and executed by one or more computer processors, cause the one or more computer processors to perform steps including: receiving pairs of conversation text and summaries; generating training data by injecting hallucinations into the conversation text or the summaries; fine-tuning a large language model (LLM) with the generated training data using a loss function, wherein the loss function is direct preference optimization; providing validation conversation text to the fine-tuned LLM; generating a lookback ratio vector comprising attention paid by the fine-tuned LLM to content at each token generation step; extracting token probabilities at each layer of the fine-tuned LLM into a logit-based vector; concatenating the lookback ratio vector and the logit-based vector; classifying the concatenated lookback ratio vector and the logit-based vector using a logistic regression classifier; deploying the fine-tuned LLM to a production environment.

In an embodiment, the step of generating training data by injecting hallucinations into the conversation text or the summaries comprises: extracting named entities from the conversation text or the summaries; factually augmenting the named entities within the conversation text or the summaries; and introducing external content into the summaries by paraphrasing parts of the conversation text or the summaries.

In an embodiment, the hallucinations are injected by replacing a proportion of the named entities with related but false values, or by paraphrasing the summaries and injecting hallucinations.

In an embodiment, the hallucinations are injected according to a hallucination ratio, a location in the conversation text or summaries, and/or a natural language inference sentiment of the conversation text or the summary.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for enhancing large language model reliability with hallucination averse fine-tuning and detections according to an embodiment;

FIG. 2 illustrates a method for enhancing large language model reliability with hallucination averse fine-tuning and detections according to an embodiment;

FIG. 3 depicts an exemplary computing system for implementing aspects of the present disclosure.

### DETAILED DESCRIPTION OF PREFERRED EMBODIMENTS

Systems and methods for enhancing large language model reliability with hallucination averse fine-tuning and detections are disclosed.

Embodiments are generally directed to an end-to-end framework to enhance the faithfulness of LLMs, including small language models, through a sophisticated preference-optimization paradigm. Embodiments may include a data generation module that generates training data by controlled hallucination injection into conversation text or a paired summary. The training data is used by preference-based fine-tuning methods which improves the fidelity of generated responses in relation to the conversation text.

Embodiments may further include a real-time hallucination detection mechanism that exploits latent features from the fine-tuned language LLMs to discern hallucinations within the LLM's own outputs and in pre-existing text generations. The hallucination detection mechanism has complete access to the LLM parameters and may use a lookback ratio vector that assesses the relative attention paid to the context at each token generation step of the LLM and a logit-based vector that includes pooled token probabilities at each layer of the LLM. The logit-based vector and the lookback vectors may be concatenated to ensure that the information extracted from both lookback vector and logit-based vector are received, as they capture different information. This may be used by a classifier to classify the LLM.

The process is repeated based on a validation loss.

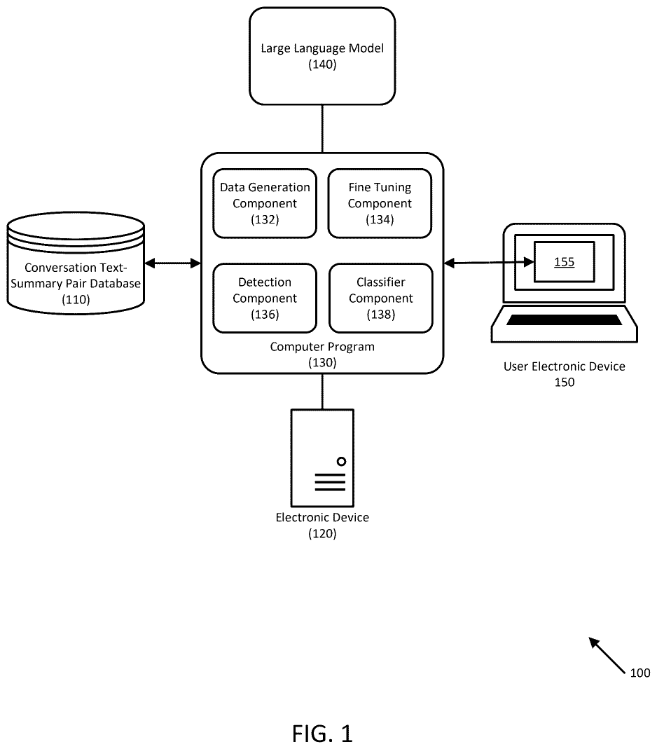

Referring to FIG. 1, a system for enhancing LLM reliability with hallucination averse fine-tuning and detections is disclosed according to an embodiment. System 100 may include text-summary pair database 110 that may include text—summary pairs, such as conversation text paired with its ground-truth summary. System 100 may also include electronic device 120, such as a server (e.g., cloud-based and/or physical), computers (e.g., workstations, desktops, laptops, notebooks, tablets, etc.), smart devices (e.g., smart phones), Internet of Things (IoT) appliances, etc. Electronic device 120 may execute computer program 130 that may train large language model (LLM) 140.

Computer program 130 may include a plurality of components, such as computer programs or scripts. For example, computer program 130 may include data generation component 132, fine tuning component 134, and detection component 136.

Data generation component 132 may facilitate controlled hallucination injection into ground truth data samples thus providing high quality data which contains rejected responses and can be used for fine-tuning. For example, data generation component 132 may inject hallucinations into ground truth data samples from text-summary pair database 110 in a controlled manner to ensure that the semantic and lexical style of the response remains consistent with the ground truth response.

Fine tuning component 134 may employ Direct Preference Optimization (DPO) as the core preference based optimization objective to train a given LLM. The data generated by the data generation component may be used to fine-tune LLMs to enhance their faithfulness. Preference-based optimization allows for fine-tuning a given LLM for the downstream task while encouraging model faithfulness with respect to the reference source.

DPO may be used to align the LLM behavior to be highly faithful, where for a given input x, the chosen response, y_{w}, is designated as one devoid of hallucinations, and the rejected response, yₗ, is designated as the synthetically generated hallucinated response. Computer program 130 aims to reinforce LLM behavior that penalizes various forms of hallucination, enabling the LLM to implicitly learn to generate more faithful responses.

DPO works for scenarios where there is one chosen response and only one corresponding rejected response. In settings where for every chosen response there are multiple rejected responses, other preference-based algorithms, such as additive DPO, a modified Plackett-Luce DPO (see Plackett “The analysis of permutations” 701 Journal of the Royal Statistical Society. Series C (Applied Statistics), 24(2): 193-202 (1975) and Luce, “Individual choice behavior,” volume 4, (1959), the disclosures of each of which is hereby incorporated, by reference, in its entirety), or Listwise Preference Optimization through Learning-to-Rank (LiPO) (see Liu et al., “LiPO: Listwise Preference Optimization through Learning-to-Rank” available at arxiv.org/abs/2402.01878, the disclosure of which is hereby incorporated, by reference, in its entirety).

Other preference-based algorithms may also be used for fine-tuning LLMs for multiple alignment behaviors (e.g., faithfulness and harmlessness) at once.

Detection component 136 may detect hallucinations. This may include calculating probability vectors by extracting token probabilities at each layer and pooling them into a logit-based (e.g., logistic regression) vector. A lookback ratio vector may assess the relative attention paid to the context at each token generation step of the LLM. Both the vectors encode complementary information crucial for detecting hallucination.

Next, the logit-based vector and the lookback vectors may be concatenated and passed through classifier 138 to classify a given input as hallucinated or true or false. The logit-based vector and the lookback vectors may be concatenated to ensure that the information extracted from both lookback vector and logit-based vector are received, as they capture different information. Specifically, the lookback vector captures the relative importance given to the context while generating a given token, while logit-based vector captures the model dynamics or state during token generation.

System 100 may further include user electronic device 150, such as a computer, a smart device, an IoT appliance, etc. that may execute user computer program 155. User computer program 155 may interact with computer program 130.

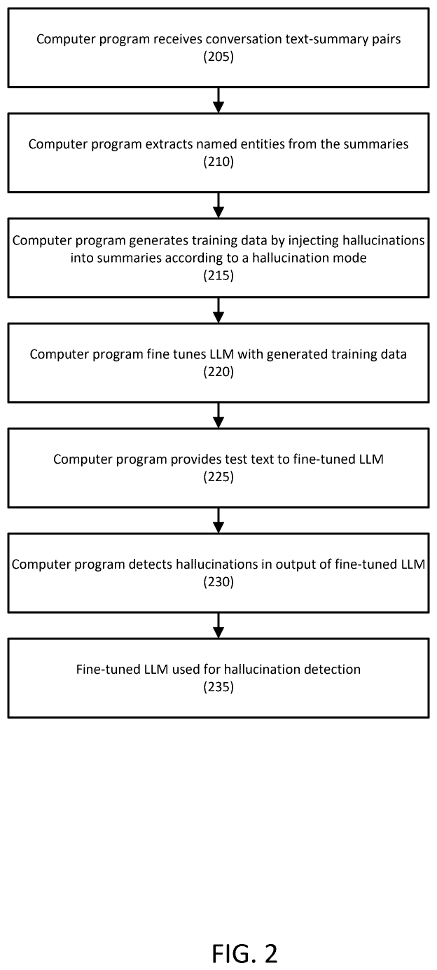

Referring to FIG. 2, a method for enhancing LLM reliability with hallucination averse fine-tuning and detections is disclosed according to an embodiment.

In step 205, a computer program executed by an electronic device may receive data, such as conversation text-summary pairs. For example, the data may include pairs of conversation text and their summaries (e.g., ground truths, such as summaries that have been confirmed to be accurate).

In step 210, the computer program may extract named entities from the summaries.

In step 215, the computer program may generate training data by injecting hallucinations into the summaries according to a preference. The data generation process may involve a two-step hallucination injection process.

First, intrinsic hallucinations may be introduced by factually augmenting entities within the conversation text and the ground truth summaries. Next, extrinsic hallucinations may be introduced by adding external context (i.e., context that is not derived from the LLM) by paraphrasing parts of the summary. This dual approach is executed in a controlled manner to ensure that the semantic and lexical style of the response remains consistent with the ground truth response.

In one embodiment, the hallucinations may be injected into the summary in a standard mode, a factual mode, or in a paraphrase mode. The mode may be selected by the user based on the amount and type of hallucinations desired to be introduced. For example, standard mode may inject hallucinations into the summary according to a hallucination ratio, a location, and a natural language inference (NLI) sentiment, parameters that may be selected by the user. For example, the computer program may inject a number of hallucinations required to mee the hallucination ratio, such the ratio of the number of hallucinated named entities to the total number of named entities.

The location may specify the location (e.g., within a sentence, within a paragraph, etc.) for the hallucination to be inserted.

The NLI sentiment may be used to control the sentiment of the injected hallucination. There are three possible sentiments: neutral (e.g., the generated text is neutral to the context, contradict (the final text contradicts the context), and entail (e.g., the final text entails the context).

In another embodiment, hallucinations may be injected into the conversation text, and then a summary for the hallucinated conversation text may be generated.

An example of a standard mode LLM prompt is as follows: “Complete the given text by adding 5-10 more sentences to the <location> of the text so that the final text <nli_sentiment> the general context: <text>”.

Next, the factual mode requires first identifying the named entities in the response and then replacing a proportion of these entities with related but false values. The hallucinated summary is then paired with the original conversation text as a training data pair.

An example of a factual mode LLM prompt is as follows: “For each item in the list, provide a close but different value. Output the answer in JSON format, with the key as the item and the value as the new value. Ensure the output is valid JSON. Only output the JSON and nothing else. Items: <list_of_entities_to_augment>”.

The paraphrase mode may prompt the LLM to paraphrase parts of the summary such that the original context of the summary remains the same while introducing subtle hallucinations. Since only parts of the summary—the ground truth response—are paraphrased, the ground truth response structure is preserved. This mode of hallucination injection may use extrinsic hallucination injection into the ground truth response that involves the addition of unverifiable information. The training data pair includes the original conversation text and the hallucinated summary.

An example of a paraphrase mode LLM prompt is as follows: “You are a highly skilled paraphrasing agent with an exceptional ability to rephrase sentences while preserving their original meaning and context. Your task is to take the given sentence and transform it into a new version that is both coherent and contextually accurate. Feel free to enhance the sentence with relevant details or insights that align with the original intent, showcasing your ability to enrich the content subtly. Only output the new sentence. Here is the sentence to rephrase: <sentence>”.

In step 220, the computer program may fine tune the LLM with the generated training data to enhance their faithfulness. Preference-based optimization allows for fine-tuning a given LLM for the downstream task while encouraging LLM faithfulness with respect to the reference source.

In one embodiment, the generated training data may be passed to the LLM and the LLM may be trained using DPO as the loss function. This may include comparing the ground truth to the what the LLM generates. Gradients may be used to determine the difference between the predicted and ground truth summary, and are used as a signal to update the internal weights of the LLM. Continuing this process, results in a final trained model which is capable of generating less hallucinated and more faithful responses.

In step 225, the computer program may provide validation conversation text to the fine-tuned LLM with a prompt to summarize the validation conversation text. The LLM may be taken out of training mode in order to receive and process the validation conversation text. For example, the computer program may stop the gradient updates, which means when data passes through the LLM, the LLM no longer updates its gradients.

The validation conversation text may be associated with ground truth summaries.

In step 230, the computer program may detect hallucinations in output of fine-tuned LLM. For example, the computer program may analyze the LLM's behavior during text generation to quantify the attention paid to context while generating tokens (e.g., a lookback ratio). For example, generated tokens that pay less attention to context are more likely to be hallucinated. This metric may be used to flag unsupported or fabricated information, and is effective to understand what portion of generated output would need further analysis.

The detection component may be used to detect hallucinations. This may include calculating probability vectors by extracting token probabilities at each layer and pooling them into a logit-based vector. A lookback ratio vector that assesses the relative attention paid to the context at each token generation step may also be computed. Both the vectors encode complementary information crucial for detecting hallucination.

Next, the logit-based vector and the lookback ratio vectors may be concatenated and passed through a classifier, such as a logistic regression classifier, to classify a given input as hallucinated or true. For example, the generated training data may be input to the fine-tuned LLM, and the attention weights of the fine-tuned LLM may be retrieved and used to calculate lookback ratios. Examples of lookback ratios are described in Chuang et al., “Lookback Lens: Detecting and Mitigating Contextual Hallucinations in Large Language Models Using Only Attention Maps,” available at arxiv. org/pdf/2407.07071 (2024), the disclosure of which is hereby incorporated, by reference, in its entirety.

The logistic regression classifier may then output a final binary classification label (e.g., 0=no hallucination, 1=hallucination or similar).

In one embodiment, the computer program may monitor the validation loss, which generally decreases as the fine-tuned LLM learns. Once there is an inflection (e.g., the validation loss increases), the computer program may stop training.

In step 235, the computer program may use the fine-tuned LLM for hallucination detection in a production environment, such as an environment where real data may be processed by the fine-tuned LLM.

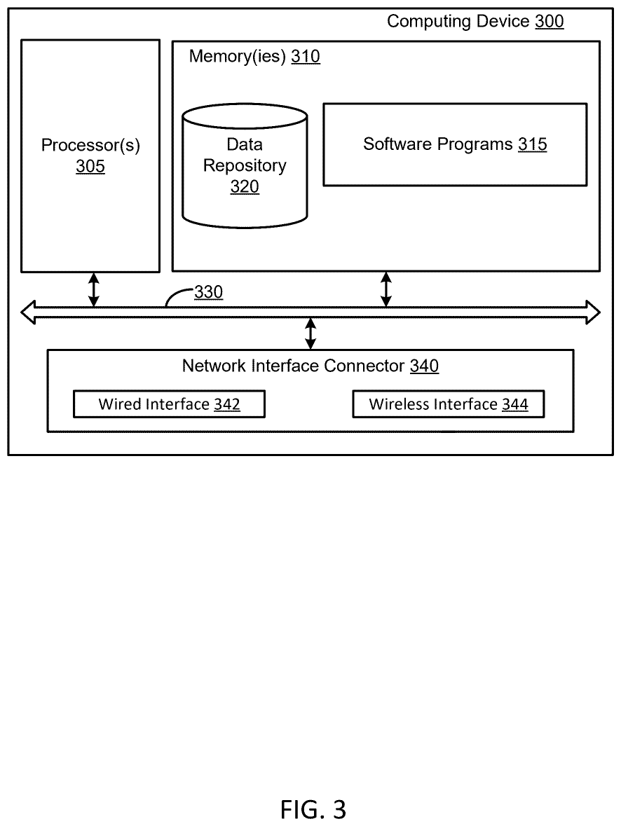

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

What is claimed is:

1. A method, comprising:
receiving, by a computer program executed by an electronic device, pairs of conversation text and summaries;
generating, by the computer program, training data by injecting hallucinations into the conversation text or the summaries;
fine-tuning, by the computer program, a large language model (LLM) with the generated training data using a loss function;
providing, by the computer program, validation conversation text to the fine-tuned LLM;
generating, by the computer program, a lookback ratio vector comprising attention paid by the fine-tuned LLM to content at each token generation step;
extracting, by the computer program, token probabilities at each layer of the fine-tuned LLM into a logit-based vector;
concatenating, by the computer program, the lookback ratio vector and the logit-based vector;
classifying, by the computer program, the concatenated lookback ratio vector and the logit-based vector using a logistic regression classifier; and
deploying, by the computer program, the LLM to a production environment.

2. The method of claim 1, wherein the step of generating training data by injecting hallucinations into the conversation text or the summaries comprises:
extracting, by the computer program, named entities from the conversation text or the summaries;
factually augmenting, by the computer program, the named entities within the conversation text or the summaries; and
introducing, by the computer program, external content into the summaries by paraphrasing parts of the conversation text or the summaries.

3. The method of claim 2, wherein the hallucinations are injected by replacing a proportion of the named entities with related but false values.

4. The method of claim 1, wherein the hallucinations are injected according to a hallucination ratio, a location in the conversation text or summaries, and/or a natural language inference sentiment of the conversation text or the summaries.

5. The method of claim 1, wherein the hallucinations are injected by paraphrasing the summaries and injecting hallucinations.

6. The method of claim 1, wherein the loss function is direct preference optimization.

7. A system, comprising:
a database comprising a plurality of conversation text-summary pairs;
an electronic device executing a computer program; and
a large language model (LLM);
wherein:
the computer program is configured to receive pairs of conversation text and summaries;
the computer program is configured to generate training data by injecting hallucinations into the conversation text or the summaries;
the computer program is configured to fine-tune the LLM with the generated training data using a loss function;
the computer program is configured to provide validation conversation text to the fine-tuned LLM;
the computer program is configured to generate a lookback ratio vector comprising attention paid by the fine-tuned LLM to content at each token generation step;
the computer program is configured to extract token probabilities at each layer of the fine-tuned LLM into a logit-based vector;
the computer program is configured to concatenate the lookback ratio vector and the logit-based vector;
the computer program is configured to classify the concatenated lookback ratio vector and the logit-based vector using a logistic regression classifier;
the computer program is configured to detect hallucinations in an output of the fine-tuned LLM; and
the computer program is configured to deploy the fine-tuned LLM to a production environment.

8. The system of claim 7, wherein the hallucinations are injected into the conversation text or the summaries by:
the computer program is configured to extracting named entities from the conversation text or the summaries;
factually augmenting the named entities within the conversation text or the summaries; and
introducing external content into the summaries by paraphrasing parts of the conversation text or the summaries.

9. The system of claim 8, wherein the hallucinations are injected by replacing a proportion of the named entities with related but false values.

10. The system of claim 7, wherein the hallucinations are injected according to a hallucination ratio, a location in the conversation text or summaries, and/or a natural language inference sentiment of the conversation text or the summary.

11. The system of claim 7, wherein the hallucinations are injected by paraphrasing the summaries and injecting hallucinations.

12. The system of claim 7, wherein the loss function is direct preference optimization.

13. A non-transitory computer readable storage medium, including instructions stored thereon, which when read and executed by one or more computer processors, cause the one or more computer processors to perform steps comprising:
receiving pairs of conversation text and summaries;
generating training data by injecting hallucinations into the conversation text or the summaries;
fine-tuning a large language model (LLM) with the generated training data using a loss function, wherein the loss function is direct preference optimization;
providing validation conversation text to the fine-tuned LLM;
generating a lookback ratio vector comprising attention paid by the fine-tuned LLM to content at each token generation step;
extracting token probabilities at each layer of the fine-tuned LLM into a logit-based vector;
concatenating the lookback ratio vector and the logit-based vector;
classifying the concatenated lookback ratio vector and the logit-based vector using a logistic regression classifier; and
deploying the fine-tuned LLM to a production environment.

14. The non-transitory computer readable storage medium of claim 13, wherein the step of generating training data by injecting hallucinations into the conversation text or the summaries comprises:
extracting named entities from the conversation text or the summaries;
factually augmenting the named entities within the conversation text or the summaries; and
introducing external content into the summaries by paraphrasing parts of the conversation text or the summaries.

15. The non-transitory computer readable storage medium of claim 14, wherein the hallucinations are injected by replacing a proportion of the named entities with related but false values, or by paraphrasing the summaries and injecting hallucinations.

16. The non-transitory computer readable storage medium of claim 14, wherein the hallucinations are injected according to a hallucination ratio, a location in the conversation text or summaries, and/or a natural language inference sentiment of the conversation text or the summary.
